(19) United States
(12) Patent Application Publication
(10) Pub. No.: US 2011/0119873 A1
(43) Pub. Date: May 26, 2011

(54) PULL LEAD HOLDER / ANCHOR INDICATOR

(76) Inventor: MARIE MANVEL, MARINA DEL REY, CA (US)

(21) Appl. No.: 12/912,807

(22) Filed: Oct. 27, 2010

Related U.S. Application Data
(63) Continuation-in-part of application No. 12/573,759, filed on Oct. 5, 2009.
Application No. 12/573,759 is a continuation-in-part of application No. 12/424,467, filed on Apr. 15, 2009.
(60) Provisional application No. 61/289,087, filed on Dec. 22, 2009.
(60) Provisional application No. 61/259,087, filed on Nov. 6, 2009.
(60) Provisional application No. 61/114,417, filed on Nov. 13, 2008.

(51) Int. Cl. E06B 9/78

(52) U.S. Cl. 24/115 R

(57) ABSTRACT

A pull lead holder indicating a pulling direction of the pull lead for a desired operation of a device, the pull lead holder comprising: a directional indicator selected from the group consisting of a variation in color, a variation in texture, and combinations thereof, so that a pulling direction is indicated for a desired operation of such device.

This application claims priority to U.S. Provisional Application Ser. No. 61/259,087 filed Nov. 6, 2009, which is incorporated herein by reference in its entirety. Further, this application is a continuation in part of application Ser. No. 12/573,759, filed Oct. 5, 2009, and is also a continuation in part of U.S. application Ser. No. 12/424,467, filed on Apr. 15, 2009 titled “INDICATOR PULL LEAD”, which claims priority to U.S. Provisional Application Ser. No. 61/114,417 filed Nov. 13, 2008, all of which are incorporated herein by reference in their entirety.

### FIELD OF THE INVENTION

The present invention relates to an attachment that is variably colored textured or marked that contains or holds the opposing pull leads used for a device operation to indicate direction, and, more particularly, to indicate pull direction. This device may be attached to a wall or a floor or window casing or any similar object.

### BACKGROUND OF THE INVENTION

Window coverings typically use a pull lead, such as a pull cord, a link chain, a bead chain or a ball chain, to rotate a series of vertical or horizontal slats, or open or close the window covering. By pulling on one side of the lead, the slats rotate in one direction, e.g., to the right, or the blinds or curtains open. By pulling on the other side of the lead, the slats rotate in the opposite direction, e.g., to the left, or the blinds or curtains close. Some window coverings have pull leads that are anchored to the floor, to the wall, or to the window casing so that the pull lead may be pulled up or down to operate the window covering.

However, the user has no indication as to which side of the lead will perform the desired operation. The user must randomly choose one side to determine the operation performed by pulling on that side, which may not be the desired operation. The resulting undesired movement of the window covering results in user frustration and wasted time.

In addition to frustrating the operator, pulling the incorrect lead introduces unnecessary wear and tear on the mechanisms of the window covering. For example, if the window covering is opened fully, a pull on the wrong lead stresses the lead and the mechanism because the window covering does not move in response to the downward pulling force.

Further, some users with limited sight or users in darkened rooms may have difficulty observing the pull lead, and some users may have difficulty grasping the pull lead. Additionally, there are other devices, such as machines and lighting, that are operated with a pull lead, which may be frustrating for the user to operate due to lack of a directional indicator.

### SUMMARY OF THE INVENTION

An embodiment of the present invention provides a holder indicating a pulling direction of a pull lead for a desired operation of a device. The holder separates and indicates the opposing pull leads. The holder includes a directional indicator on or incorporated within the surface of the part that holds a selected pull lead consisting of a variation in color, a variation in texture, and combinations thereof, so that a pulling direction is indicated for a desired pull lead operation of such device. The first part or one part of the holder may be a different color than the second part. The directional indicator on the holder may include indentations. The directional indicator may include a non-slip material. The directional indicator may include a color gradient. The directional indicator may include an object. The directional indicator may include a decorative pattern. The directional indicator may include an arrow. The directional indicator may be etched into the surface of the holder. The directional indicator may include an application of a decal. The directional indicator may include a raised portion. The directional indicator may glow in the dark. The directional indicator may be illuminated.

The directional indicator may include a sleeve about the pull lead. The sleeve may be clear or colored to indicate direction. The sleeve may be about at least: the first bead, the second bead, and the shank. The sleeve may include a variation in color. The sleeve may include a variation in texture.

A first section of the holder holding the pull lead may include a first directional indicator to indicate that pulling the first section of the pull lead will result in a first operation of the device, and a second section of the holder may include a second directional indicator to indicate that pulling the second section of the pull lead in that section will result in a second operation of the device.

Another embodiment of the present invention provides a holder indicating a pulling direction of the pull lead for a desired operation of a device, the directional indicator consisting of a variation in color, a variation in texture, and combinations thereof, so that a pulling direction is indicated for a desired operation of such device.

A first section of the holder may include a first directional indicator to indicate that pulling the first section of the pull lead will result in a first operation of the device, and a second section of the holder may include a second directional indicator to indicate that pulling the second section of the pull lead will result in a second operation of the device.

The first part and the second part of the directional holder indicator may include a receptacle adapted to receive the opposing sides of the pull lead.

Another embodiment of the present invention provides a method for positioning a directional indicator on opposing sides of the device, wherein the holder includes a directional indicator along a length of the holder, the method including: attaching the pull cord to the device so that the directional indicator on a first side of the holder indicates a first direction and the directional indicator on a second side of the holder indicates a second direction opposite the first direction, wherein pulling the first side of the pull cord contained in the holder performs a first

### BRIEF DESCRIPTION OF THE DRAWINGS

FIG. 1 is a perspective view of a pull lead holder according to an embodiment of the present invention.

### DETAILED DESCRIPTION OF THE INVENTION

The detailed description set forth below in connection with the drawings is intended as a description of embodiments of a color and/or texture variability for use with a pull lead holder in accordance with the present invention and is not intended to represent the only forms in which the invention may be constructed or utilized. It is to be understood that the same or equivalent functions and structures may be accomplished by different embodiments that are also intended to be encompassed within the spirit and scope of the invention. As denoted elsewhere herein, like element numbers indicate like elements or features.

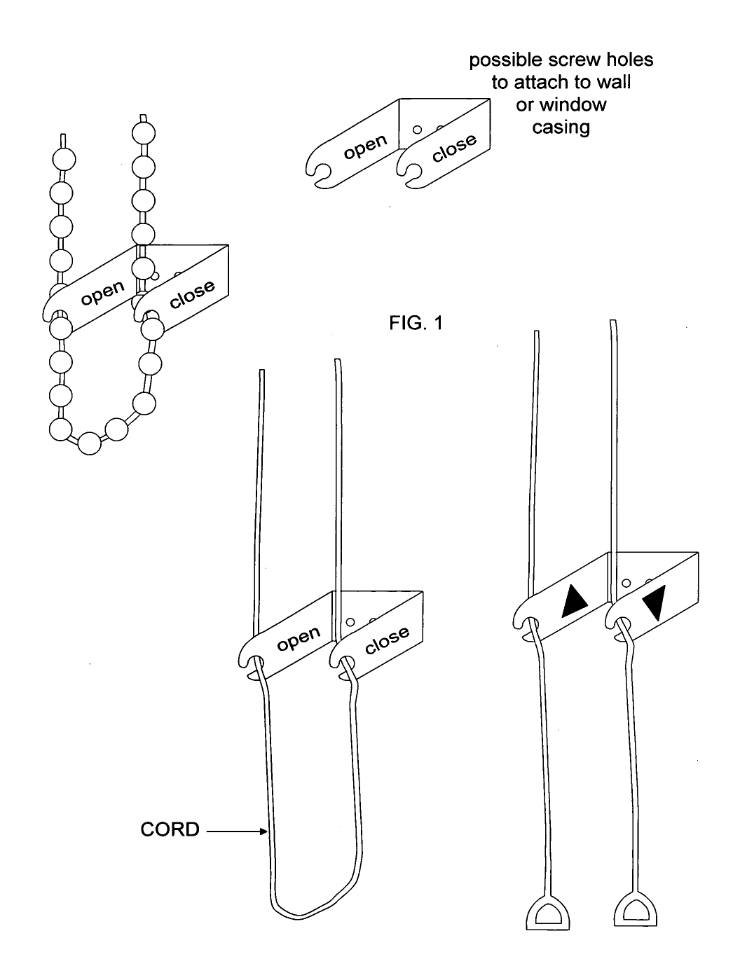

As shown in FIG. 1 words are used to provide a directional indicator to indicate the direction the pull chain should be pulled to operate a window covering or other device as desired. A variation in color or texture may be used so an individual may observe or feel which side of the pull chain to pull to achieve the desired effect to open or close a window covering or device, such as a horizontal or mini blind, vertical blinds, or curtains. A user would open or close the window covering or other device by grasping a length of the pull chain in the proper side of the holder. The visual signal used to indicate direction may also incorporate symbols, such as, for example, arrows or indentations and the symbols may glow in the dark.

A visually and texturally distinctive pattern may also be formed by applying sequins or rhinestones to the outer surface of the holder. Other distinctive elements could also be used. The distinctive elements may also be applied in a wide variety of patterns and/or symbols to designate a direction on the holder for operation of the pull lead.

The texture variation or texture gradation may be formed when the holder is manufactured or applied later. The design may be plastic or metal.

If applied, it may be any other suitable material, such as composites, recycled materials, silicone, or latex rubber. In other embodiments of the present invention, the decoration texture or coloration may be other shapes, including, but not limited to, an arrow, an elliptical or round shape, or a multi-faceted shape.

The color pattern, or any other directional pattern, on the holder may be applied to the entire length of the holder.

According to another embodiment of the present invention, the opening of the holder that grasps the lead may have varying diameters so that it does not tightly hold the lead. In another example, the holder may be formed of a clear material, such as plastic. The clear material may also incorporate colored or decorative elements such as a colored dye or sparkles. These decorative elements may be arranged to indicate a direction that the pull chain should be pulled.

In another embodiment of the present invention, there is a gradation of the colors, or a gradation in a glow-in-the-dark material, along the holder from lighter to darker. This would signal to a user that they should pull the lead held in the darker section of the holder to close and the lighter section of the holder to open.

The indictor holder may be fixed to a stationary object, such as the floor or the window casing.

Alternatively, the holder could be made from material that incorporates a light that would make it easy to see in the dark.

Further, the holder may be different colors to achieve a desired appearance, or may be formed of a clear material, such as an acrylic polymer like Lucite.

In another embodiment of the present invention, the holder may be clear with an internal design or symbol, such as glitter, a flower, or an arrow, that is opaque.

A person of ordinary skilled in the art will appreciate that the holder may be formed into numerous different shapes that would be suitable for different applications. For example, parts of the holder may be shaped like an arrow, a dumbbell, a sphere, a football, or animal or action figure shapes.

In another embodiment of the present invention, the holder may be adapted for use in industrial applications, such as for operating warehouse doors or manufacturing machinery. For example, a holder, with one side being green and the other side being red, may be used for to operate a warehouse door, so that pulling the pull lead contained by the green side of the holder opens the door and pulling the lead contained in the red side of the holder closes the door. In another example, pulling the lead contained in the green side may start a piece of machinery and pulling the lead in the red side may stop a piece of machinery.

In another embodiment of the present invention, the holder may be colored red to indicate that it may be used in an emergency situation, such as an emergency chemical shower. In another embodiment of the present invention, one or both sides of the holder may be illuminated, such as with an LED light or other suitable light source, or reflective for situations where light or reflections may be desired.

In another embodiment of the present invention, may be used in conjunction with a safety device such as that available from Hunter Douglas under the name Universal Cord Tensioner, may be utilized with the indicator holder. In such an embodiment, the indicator may be on the safety device.

The opposing sides of the ends of the pull lead may be loose so that the ends are not connected or in a looped configuration.

In another embodiment of the present invention, the indicator on or incorporated in the holder may be a gradient in color or in a glow-in-the-dark material, so that one portion of the pull cord has a different appearance from another section of the holder.

In another embodiment of the present invention, the pull lead may be utilized with a vertical blind, so that pulling down on one side of the pull lead contained in the holder rotates the blinds in one direction and pulling down on the other side of the pull lead rotates the blinds in the other direction.

In another embodiment of the present invention, the pull lead may be utilized to open and close a window covering, rather than rotate blinds, so that pulling down on one side of the pull lead contained in the holder opens the window covering and pulling down on the other side of the pull lead closes the window covering.

Further, the holder, as described in numerous various variations above, may also be adapted for use with a link chain.

In another embodiment of the present invention, the space on holder is sized and shaped so that a pull cord may continue to operate through a pulley or safety device, as described above. In other words, the lead may be pulled through a pulley or safety device so that the pull cord continues to operate normally.

In another embodiment, the directional indicator holder may be screwed or nailed or taped to the wall or stationary device. As one of ordinary skill in the art would realized, there are numerous suitable methods for attaching the directional indicator to a wall, including clips, thread, and Velcro.

Although the present invention has been described through the use of exemplary embodiments, it will be appreciated by those of skill in the art that various modifications may be made to the described embodiments that fall within the scope and spirit of the invention as defined by the claims and their equivalents appended hereto. For example, aspects shown above with particular embodiments may be combined with or incorporated into other embodiments. Therefore, a directional indicator holder of the types described above may be adapted to be utilized with any type of pull lead to provide the features desired.

I claim:

1. A holder indicating a pulling direction of the pull lead for a desired operation of a device, the holder comprising two parts, each comprising a first part, and a second part; and wherein at least the first part comprises a directional indicator on a surface of that part selected from the group consisting of a variation in color, a variation in texture, and combinations thereof, so that that part holds or contains a pulling lead the direction is indicated for a desired operation of such device.

2. The holder of claim 1, wherein the first part is opposite the second part and wherein the directional indicator on each part comprises and has a different appearance or a different texture from the other part.

3. The holder of claim 1, wherein the first part is a different color than the second part.
